(19) United States
(12) Patent Application Publication
(10) Pub. No.: US 2014/0237475 A1
(43) Pub. Date: Aug. 21, 2014

(54) SLEEP/WAKE WITH SUPPRESSION AND DONATED IMPORTANCE

(71) Applicant: APPLE INC., Cupertino, CA (US)

(72) Inventors: Jairey Connie Jong, Mountain View, CA (US); Kevin James Van Vechten, San Francisco, CA (US)

(73) Assignee: APPLE INC., Cupertino, CA (US)

(21) Appl. No.: 14/181,215

(22) Filed: Feb. 14, 2014

Related U.S. Application Data
(60) Provisional application No. 61/765,636, filed on Feb. 15, 2013.

(51) Int. Cl. G06F 9/48; G06F 1/32

(52) U.S. Cl. CPC G06F 9/485; G06F 1/32
USPC 718/102

(57) ABSTRACT

A method and apparatus of a device that manages processes upon the device entering and waking from sleep mode is described. In an exemplary embodiment, the device receives a signal to wakeup the device from the sleep mode. The sleep mode includes a plurality of processes that were executing prior to the device being put into a sleep mode and the plurality of processes includes a suppressed process and an unsuppressed process. For each of the processes, the device resumes execution of that process if that process is an unsuppressed process and defers execution of the process if that process is a suppressed process.

### RELATED APPLICATIONS

Applicant claims the benefit of priority of prior, co-pending provisional application Ser. No. 61/765,636, filed Feb. 15, 2013, the entirety of which is incorporated by reference.

### FIELD OF INVENTION

This invention relates generally to process management and more particularly to managing processes during device sleep and wake.

### BACKGROUND OF THE INVENTION

A device can enter a sleep mode that is used as a low power mode for that device. This mode can save significant power consumption as compared to the device fully on because many power consuming components of the device are shutdown or in hibernation. When the device enters sleep mode, the device suspends execution of active processes and saves the contents of the volatile memory to persistent storage of the device. For example, the device saves data stored in volatile memory that is being used by applications is saved onto disk. The kernel memory is saved into a hibernate file. Upon a wake, the device resumes execution of these active processes and the virtual memory system pages in the memory for the active processes at once.

A problem can arise because, as the active processes start back up, the device can slow down as virtual memory for each of the active processes is paged into the volatile memory. Upon a wake from sleep mode, all of the active processes start back up from the point of suspension for sleep mode. This means that there are many process contending for the virtual memory stored on disk and, thus, these processes page in the application memory and resume execution at once. This can slow the device down as many process are competing at the same time before a login screen can be displayed. This situation can slow down the device responsiveness as the device comes out of the sleep mode.

### SUMMARY OF THE DESCRIPTION

A method and apparatus of a device that manages processes upon the device entering and waking from sleep mode is described. In an exemplary embodiment, the device receives a signal to wakeup the device from the sleep mode. The sleep mode includes a plurality of processes that were executing prior to the device being put into a sleep mode and the plurality of processes includes a suppressed process and an unsuppressed process. For each of the processes, the device resumes execution of that process if that process is an unsuppressed process and defers execution of the process if that process is a suppressed process.

In another embodiment, the device receives a signal that indicates the device is to be put into the sleep mode, wherein the device includes a plurality of active processes that are currently executing. The device further retrieves a list of important processes. For each of the active processes, the device determines if that active process is in the list of important processes, and marks that active process as suppressed, if that active process is not in the list of important processes. Execution of a suppressed process is deferred upon the device waking from sleep mode.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is a block diagram of one embodiment of a device with multiple active processes prior to entering a sleep mode.

FIG. 2 is a block diagram of one embodiment of a device with multiple active processes prior to entering a sleep mode and some of the processes are mark as suppressed.

FIG. 3 is a block diagram of one embodiment of a device waking from sleep mode with suppressed and unsuppressed processes.

FIG. 4 is a block diagram of one embodiment of a device waking from sleep mode with suppressed and unsuppressed processes, and one unsuppressed process unsuppressing a suppressed process.

FIG. 5 is a flowchart of one embodiment of a process to suppress process(es) prior to a device going into sleep mode.

FIG. 6 is a flowchart of one embodiment of a process to wake from a sleep mode with suppressed and unsuppressed processes.

FIG. 7 is a flowchart of one embodiment of a process to unsuppress a suppressed process.

FIG. 8 is a block diagram of one embodiment of a process suppression module to suppress process(es) prior to a device going into sleep mode.

FIG. 9 is a block diagram of one embodiment of a wake module to wake from a sleep mode with suppressed and unsuppressed processes.

FIG. 10 is a block diagram of one embodiment of a message module to unsuppress a suppressed process.

FIG. 11 illustrates one example of a typical computer system, which may be used in conjunction with the embodiments described herein.

FIG. 12 shows an example of a data processing system, which may be used with one embodiment of the present invention.

### DETAILED DESCRIPTION

A method and apparatus of a device that manages processes upon the device entering and waking from sleep mode is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that manages processes upon the device entering and waking from sleep mode is described. In one embodiment, a sleep mode for the device is a low power mode of the device where application data in volatile memory is stored to disk and kernel memory is saved to a hibernate file. In one embodiment, the device receives an indication that the device is to be put into sleep mode. In response, the device marks each of the active processes as suppressed if that active process is not one of the important processes. An important process is a process whose execution is resumed upon the device waking from a sleep mode. For example and in one embodiment, an important process can be a login window, window server, launch daemon, and application launch board. In contrast, a suppressed process is a process where the execution of this process can be deferred until after the user begins to interact with the device when the device wakens from the sleep mode. After the active processes are analyzed by the device, the device enters sleep mode.

Upon the device waking from the sleep mode, the device determines which of the previously active processes are suppressed processes and which processes are unsuppressed. For each of the suppressed processes, the device defers execution of these processes. For the unsuppressed processes, the device resumes the execution of these processes. In one embodiment, for each of the unsuppressed processes, the device pages in the application memory from the disk and resumes execution.

For the suppressed processes, execution of these processes can resume upon either the device signaling that suppressed processes can resume execution or if one of the suppressed processes receives a message from an unsuppressed process. In one embodiment, a kernel of the device receives a message from an unsuppressed process that is destined for a suppressed process. In this embodiment, the kernel unsuppresses the suppressed process and forwards the message to the destination process. This embodiment can be used to resume suppressed services whose execution can be resumed as needed. In addition, this embodiment can further be used to resume execution of suppressed user applications that receive an event due to a user interaction with this user application (e.g., mouse event, keyboard event, etc.). In one embodiment, resumption of the active processes by unsuppressed message passing can lead to a more graceful way of waking up a device form sleep mode. In another embodiment, the kernel unsuppresses the remaining suppressed process so these suppressed processes can resume execution. This embodiment can be to resume execution of suppressed user applications that do not receive an event while suppressed.

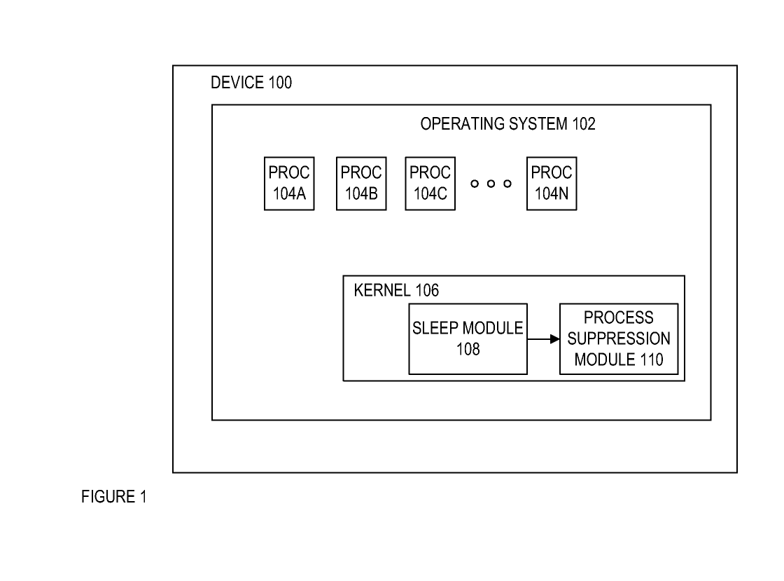

FIG. 1 is a block diagram of one embodiment of a device 100 with active processes 104A-N prior to entering a sleep mode. In one embodiment, the device 100 can be a personal computer, laptop, server, mobile device (e.g., smartphone, laptop, personal digital assistant, music playing device, gaming device, etc.), network element (e.g., router, switch, gateway, etc.), and/or any device capable of executing multiple processes and having a sleep mode. In one embodiment, the device can be a physical or virtual device. In FIG. 1, the device 100 includes an operating system 102 that is a set of software used to manage the device's hardware resources and provides common services for other running the device's programs, such as application programs. In one embodiment, the operating system 102 manages the different active processes 104A-N by time scheduling when a processor of the device 100 executes each active process 104A-N. In one embodiment, a process is an instance of a computer program that is being executed. In this embodiment, the process may be a user application that is executing as a result of user input. Examples of user processes are web surfing, word processing, email, social media, media processing, etc. Another example of a process is a system process that provides one or more services to a user application, other process, etc.

In one embodiment, the operating system 102 includes a kernel 106 that is a basic component of the operating system 102 and provides a level of abstraction for the device resources (e.g., processor, input/output systems, network resources, etc.). In addition, the kernel 106 manages the power states of the system, including sleep and wakes modes.

In one embodiment, the kernel 106 includes a sleep module 108 that handles putting the device into a sleep mode. In one embodiment, the sleep module 108 prepares the device 100 for sleep mode and puts the device 100 in sleep mode. In one embodiment, the sleep module 108 prepares the device for a sleep mode in response to an indication that the device is to enter the sleep mode (e.g., a user indicates the device to enter sleep mode, device inactivity, low battery power, thermal overload, and/or another sleep indicator). In one embodiment, the sleep module 108 uses a process suppression module 110 that marks certain executing processes as suppressed. While in one embodiment, all processes are marked as suppressed, in an alternate embodiment, less than all of the processes are suppressed. A suppressed process is one that does not resume immediately execution upon the device waking from a sleep mode. Instead, execution of the suppressed process is deferred until the suppressed process receives a message from an unsuppressed process or is explicitly unsuppressed by the kernel. For example and in one embodiment, an unsuppressed process is a system service that is executing upon the device waking from sleep and requires a service from a suppressed process. The unsuppressed process sends a message to the suppressed process, requesting the service. As the kernel handles the message forwarding to the suppressed process, the kernel unsuppresses the suppressed process, so the formerly suppressed process can fulfill the service request.

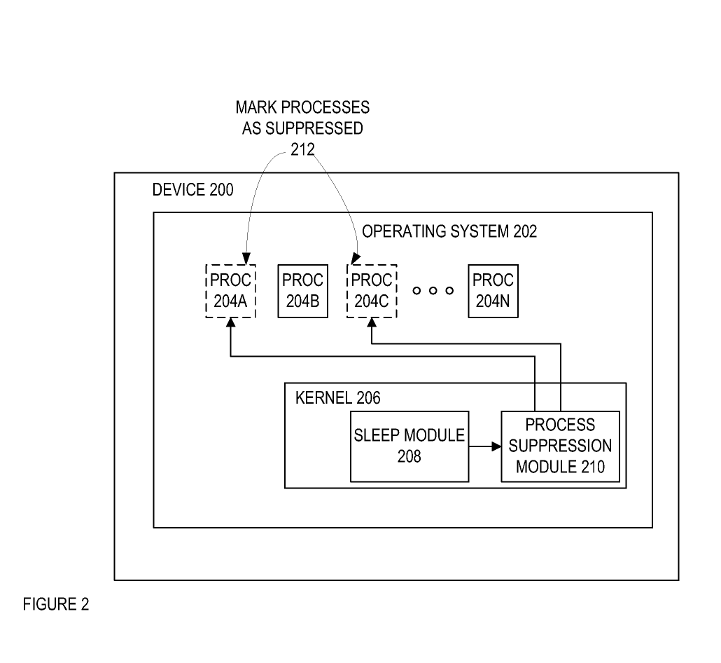

FIG. 2 is a block diagram of one embodiment of a device 200 with active processes 204A-N prior to entering a sleep mode and some of the processes are marked as suppressed. In FIG. 2, the device 200 includes an operating system 202 that is a set of software used to manage computer hardware resources and provides common services for the processes as described above in the FIG. 1. Furthermore, there a number of active processes 204A-N that are executing prior to the device 200 being put into sleep mode. In one embodiment, an active process is a running process that is being executed by the device or is scheduled for execution by the device. In addition, the operating system 202 includes a kernel 206 that provides a level of abstraction for the device resources and manages the power states of the system. The kernel 206 includes a sleep module 208 puts the device in a sleep mode. The kernel 206 further includes a process suppression module 210 to marks some or all active processes as suppressed.

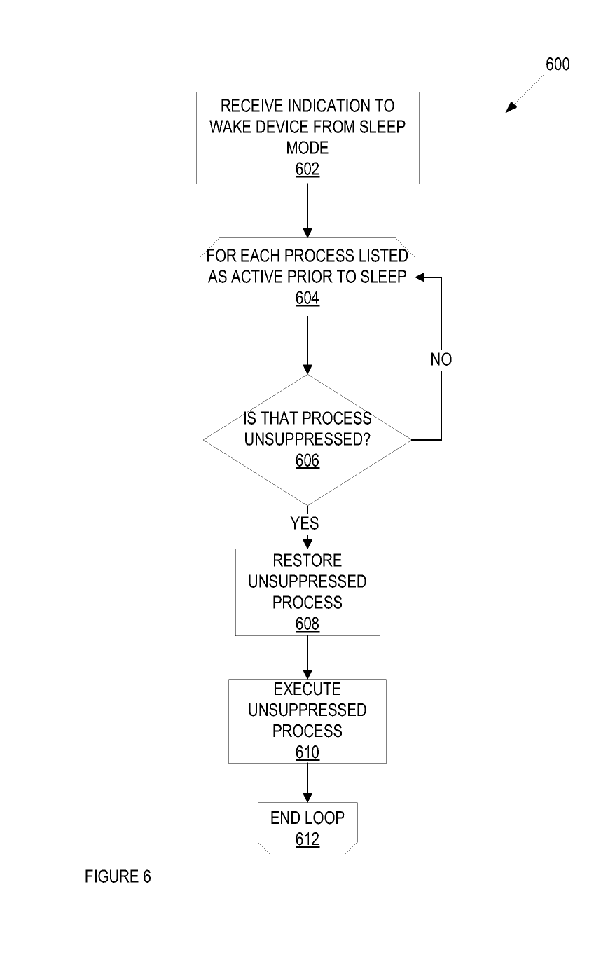

In one embodiment, the sleep module 208 invokes the process suppression module 210 to marks some or all of the active processes 204A-N as suppressed. For example and in one embodiment, active processes 204A and 204C are marked as suppressed. In this embodiment, these suppressed active processes 204A and 204C do not resume immediately execution upon the device waking from a sleep mode. Instead, execution of these suppressed processes is deferred until the suppressed processes either receive a message from an unsuppressed process or is explicitly unsuppressed by the kernel. Preparing a system for a sleep mode is further described in FIG. 6 below.

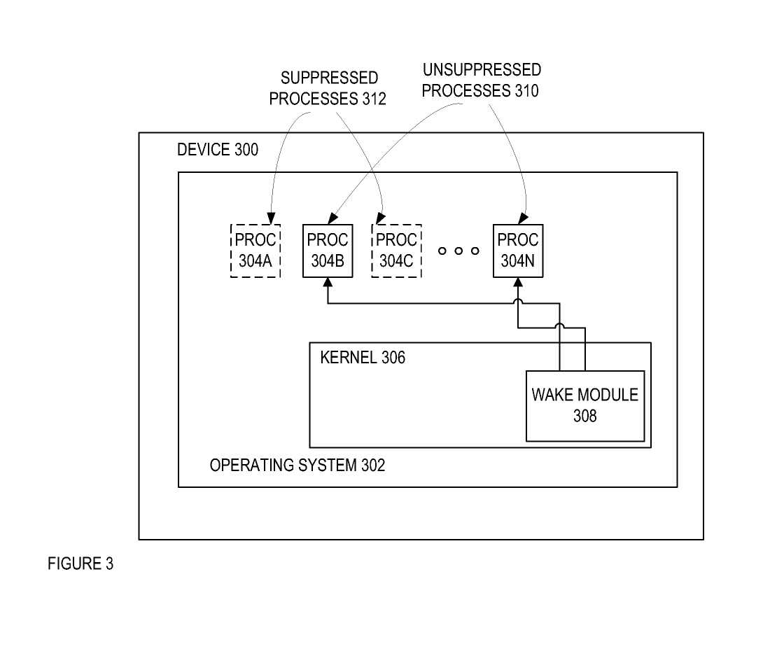

FIG. 3 is an illustration of one embodiment of a device 300 waking from sleep mode with suppressed 304A and 304C and unsuppressed processes 304B and 304D. In FIG. 3, the device 300 includes an operating system 302 that is a set of software used to manage computer hardware resources and provides common services for the processes as described above in the FIG. 1. In addition, the operating system includes a kernel 306 to provide a level of abstraction for the device resources and manage the power states of the system. The kernel 306 includes a wake module 308 that resumes the execution of the unsuppressed process. In one embodiment, the unsuppressed processes 304B and 304N are not marked as suppressed, and processes 304A and 304C are marked as suppressed. In this embodiment, the wake module resumes the execution of unsuppressed processes 304B and 304N, where these unsuppressed processes 304B and 304N resume execution by paging in the memory for these processes and the operating system 302 resumes the execution of these unsuppressed processes 304B and 304N. In one embodiment, processes that are marked for suppression are processes that are not essential system processes (e.g., user-visible applications, applications displaying a user interface, backups, search indexing, network transfers, software updates, and/or another type of low priority background task). In one embodiment, processes that are not marked for suppression are processes that are used to get the device 300 ready for normal operation. For example and in one embodiment, the unsuppressed processes 304B and 304N can be processes that are used to quickly get the device to a point where the user can interact with the system. In this embodiment, the unsuppressed processes can be processes for the login window, window server, critical system services (e.g., launch daemon,), application launch board, loopback network traffic, filesystem activity, other core system services, and/or combination thereof.

In another embodiment, if all of the processes are marked for suppression, the wake module 308 maintains a whitelist of processes that are unsuppressed prior to resuming execution of the device 300 from sleep mode. In one embodiment, these whitelisted processes can be processes that are used to quickly get the device to a point where the user can interact with the system. In this embodiment, the unsuppressed processes can be processes for the login window, window server, critical system services (e.g., launch daemon,), application launch board, loopback network traffic, filesystem activity, other core system services, and/or combination thereof. Waking a system from a sleep mode with a mix of suppressed and unsuppressed processes is further described in FIG. 6 below.

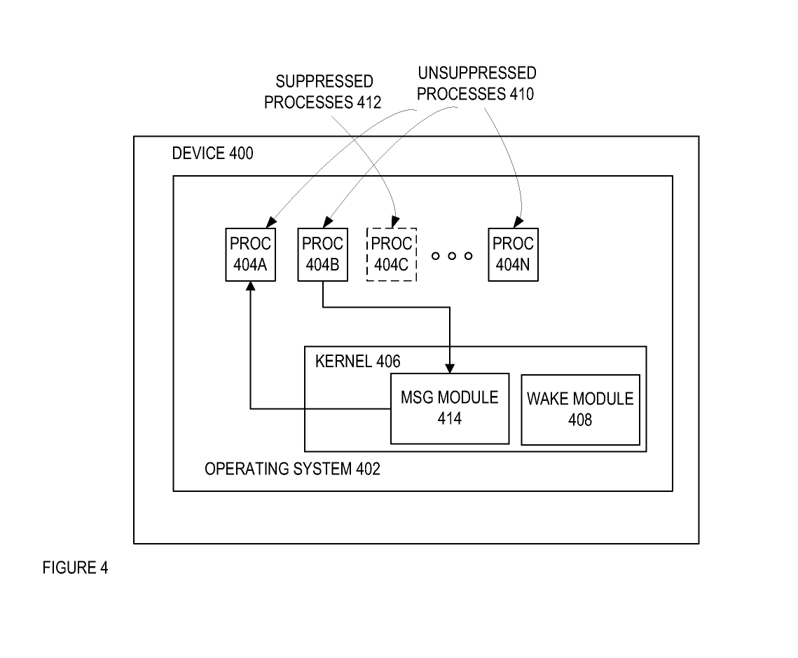

As described above, upon a wake from a sleep mode, some processes are suppressed and the execution of these processes is deferred until those processes are not longer marked for suppression. In one embodiment, these processes are unsuppressed by receiving a message from an unsuppressed process. FIG. 4 a block diagram of one embodiment of a device 400 waking from sleep mode with suppressed and unsuppressed processes, and a process 404B unsuppressing a suppressed process 404A. In FIG. 4, the device 400 includes an operating system 402 that is a set of software used to manage the device hardware resources and provides common services for the processes as described above in the FIG. 1. In addition, the operating system includes a kernel 406 that provides a level of abstraction for the device resources and manages the power states of the system. The kernel 406 includes a wake module 408 that resumes the execution of the unsuppressed process. In one embodiment, processes 404B and 404N are not marked as suppressed, and processes 404A and 404C are marked as suppressed. In this embodiment, the wake module resumes the execution of processes 404B and 404N, where these processes 404B and 404N resume execution by paging in the memory for these processes and the operating system 402 resumes the execution of these processes 404B and 404N.

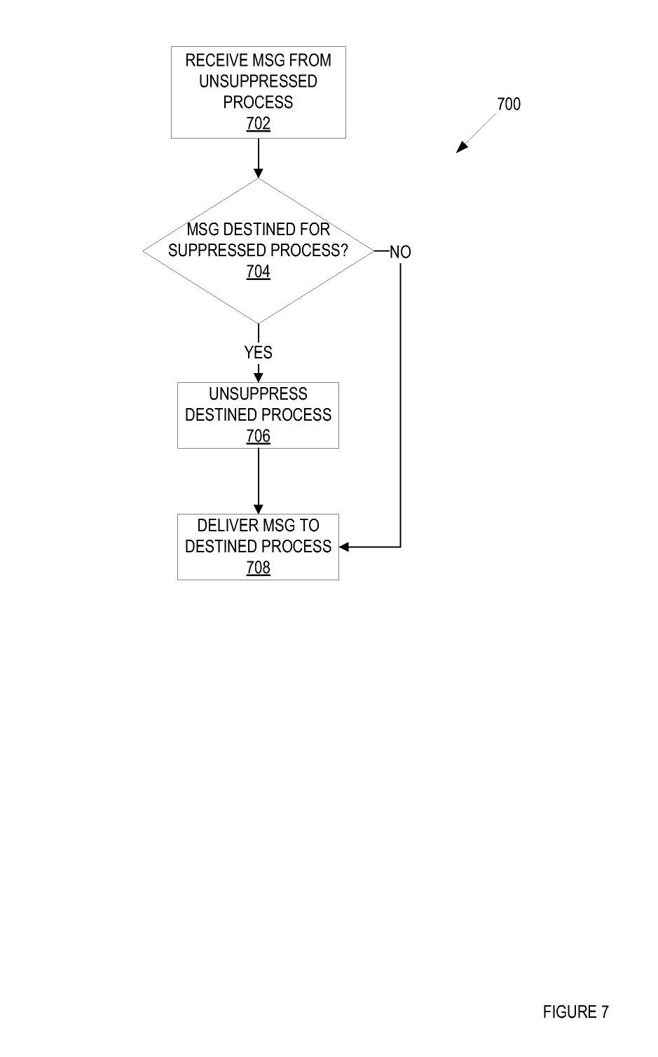

In one embodiment, the kernel 406 includes a message module 410 that processes inter-process messages. In this embodiment, the message module 410 receives messages and forwards the message to the appropriate destination process. For example and in one embodiment, the types of message the message module can handle are an interprocess communication (IPC) messages, Mach messages, and/or another type of system message. In addition, the message module can unsuppress a suppressed process if the suppressed process is to receive a message from an unsuppressed process. In this embodiment, the message module 410 receives a message from an unsuppressed process. If the message is destined for a suppressed process, the message module 410 removes the suppression mark for the destination process and forwards the message to the now-unsuppressed process. For example and in one embodiment, process 404B sends a message destined for the suppressed process 404A. In this embodiment, the message module 410 receives the message from process 404B. The message module 410 determines that the destination process for this message is suppressed and the message module 410 unsuppresses the destination process, process 404A. With the process 404A unsuppressed, the process 404A can handle the message. The message module 410 forwards to the process 404A. Unsuppressing a process based on message passing is further described in FIG. 7 below.

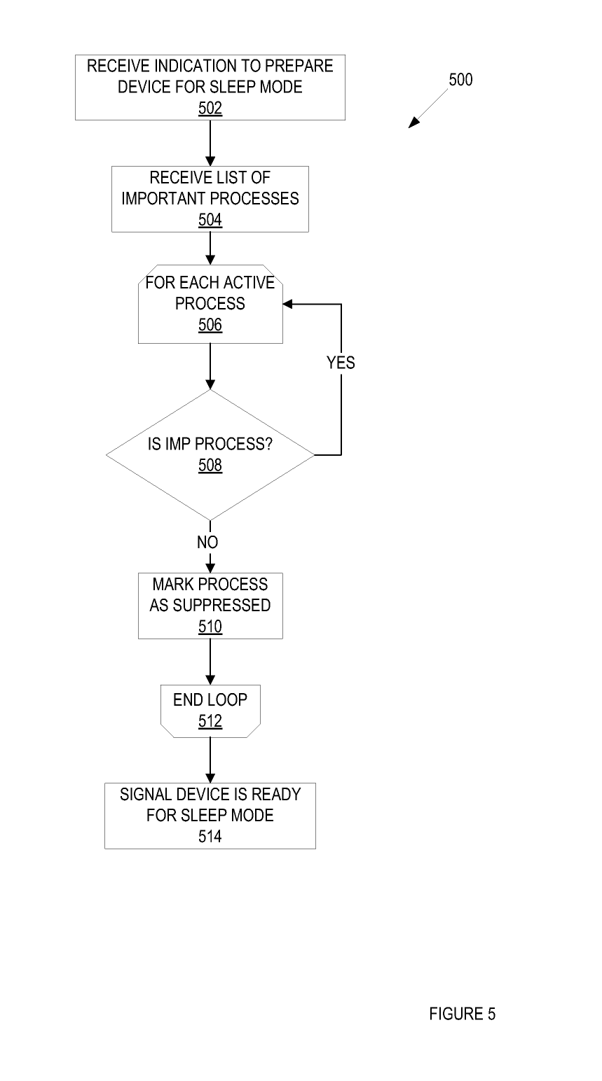

FIG. 5 is a flowchart of one embodiment of a process 500 to suppress process(es) prior to a device going into sleep mode. In one embodiment, the process suppression module 210 performs process 500 to suppress one or more processes prior to the device going into sleep mode as described in FIG. 2 above. In FIG. 5, process 500 begins by receiving an indication to prepare the device for sleep mode at block 502. In one embodiment, a sleep module sends a message to process 500 to indicate that the device is to be put into a sleep mode. At block 504, process 500 receives a list of importance processes. In one embodiment, the processes on this list are a list of processes that are to remain unsuppressed following a wake from sleep. In this embodiment, the important processes can be processes for the login window, window server, and/or critical system services (e.g., launch daemon), application launch board, loopback network traffic, filesystem activity, other core system services, and/or combination thereof.

Process 500 performs a processing loop (blocks 506-512) to mark unimportant processes for suppression by examining each active process. At block 508, process 500 determines if that process is an important one. If the process is important, the process is not marked for suppression and execution proceeds to block 506. In one embodiment, process 500 uses a whitelist to determine which of the active processes are considered important. If the process is not important, process 500 marks that process for suppression at block 510. The processing loop ends at block 512. Process 500 indicates that the device is ready for sleep mode at block 514.

As described above, a device that wakes from a sleep mode can resume execution of the unsuppressed processes and defer execution of suppressed processes. FIG. 6 is a flowchart of one embodiment of a process 600 to wake from a sleep mode with suppressed and unsuppressed processes. In one embodiment, the wake module 308 performs process 600 to wake from a sleep mode as described in FIG. 3 above. In FIG. 6, process 600 begins by receiving an indication to wake the device from a sleep mode. In one embodiment, process 600 receives the indication as a result of a user interaction (e.g., user opens a laptop lid, presses a key, mouse movement, and/or another type of user interaction that triggers a device wake or a system event (e.g., programmed wake from sleep, network activity, incoming calls (audio and/or video), push notification, filesystem activity and/or another type of system event that triggers a device wake). Process 600 performs a processing loop (blocks 604-612) to restore unsuppressed processes for each process listed as active prior to the device going into sleep mode. At block 606, process 600 determines if that process is unsuppressed. In one embodiment, process 600 determines if that process is marked as suppressed. If the process if not marked as suppressed, that process is unsuppressed. If the process is suppressed, execution proceeds to block 604.

If the process is unsuppressed, process 600 restores the unsuppressed process. In one embodiment, process 600 schedules the unsuppressed process for execution, while the suppressed processes are not (even if the suppressed processes would otherwise runnable). For example and in one embodiment, process 600 restores the login window and window server processes so that the login screen can be presented to the user without the device waiting on other processes being restored. At block 610, process 600 resumes the execution of the restored and unsuppressed process. The processing loop ends at block 612.

As described above, a suppressed process can be unsuppressed if the suppressed process receives a message from an unsuppressed process. FIG. 7 is a flowchart of one embodiment of a process 700 to unsuppress a suppressed process via message handling. In one embodiment, the message module 410 performs process 700 to handle message forwarding and unsuppressing a suppressed process as described in FIG. 4 above. In FIG. 7, process 700 begins by receiving a message from an unsuppressed process at block 702. In one embodiment, an unsuppressed process is process that has resumed execution after the device has woken up from sleep mode. For example and in one embodiment, a core device service can be an unsuppressed process (e.g., login window, window server, launch daemon, backup daemon, search indexing, application launch board, etc.). At block 704, process 700 determines if the received message destined for a suppressed process. In one embodiment, process 700 checks if the destination process is marked as suppressed. If the destination process is not suppressed, execution proceeds to block 708 below. If the destination process is suppressed, at block 706, process 700 unsuppresses the destination process. In one embodiment, process 700 removes the suppression mark for the destination process. Execution proceeds to block 708. At block 708, process 700 delivers the message to the destination process.

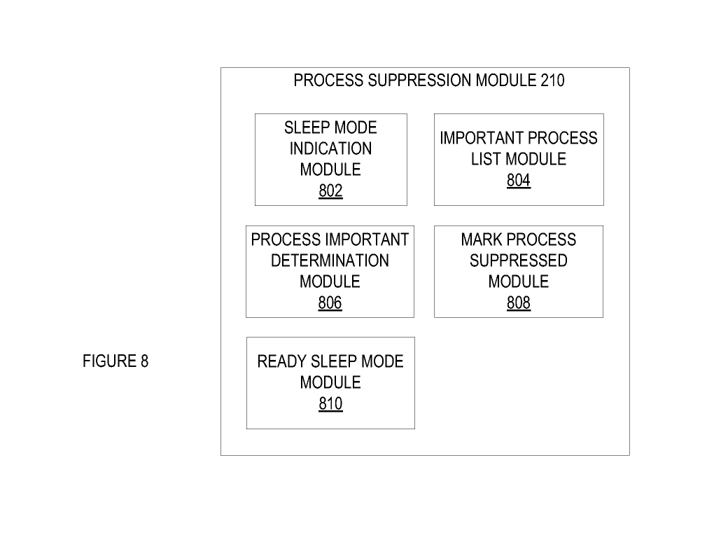

FIG. 8 is a block diagram of one embodiment of a process suppression module 210 to suppress process(es) prior to a device going into sleep mode. In one embodiment, the process suppression module 210 includes a sleep mode indication module 802, important process list module 804, process importance determination module 806, mark process suppressed module 808, and ready sleep mode module 810. In one embodiment, the sleep mode indication module 802 receives an indication that the device is to enter sleep mode as described in FIG. 5, block 502 above. The important process list module 804 retrieves a list of important processes as described in FIG. 5, block 504 above. The process importance determination module 806 determines if the process is important as described in FIG. 5, block 508 above. The mark process suppressed module 808 marks a process as suppressed as described in FIG. 5, block 510 above. The ready sleep mode module 810 indicates the device is ready for sleep mode as described in FIG. 5, block 514 above.

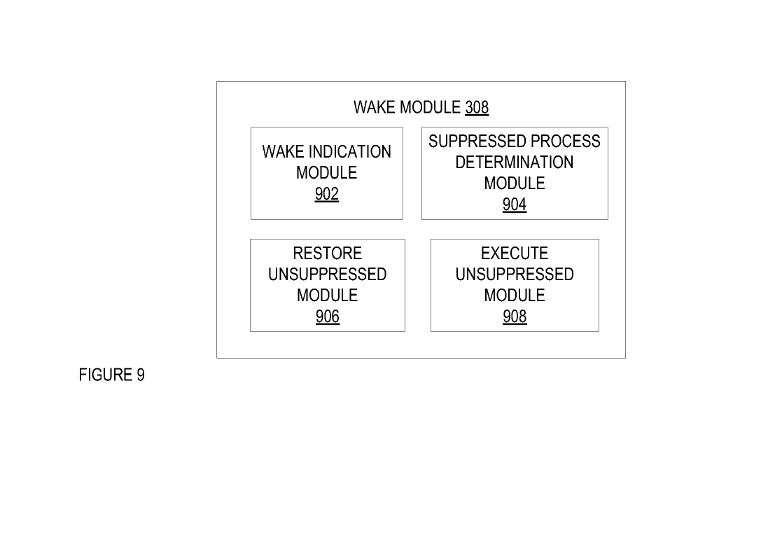

FIG. 9 is a block diagram of one embodiment of a wake module 308 to wake from a sleep mode with suppressed and unsuppressed processes. In one embodiment, the wake module 308 includes a wake indication module 902, suppressed process determination module 904, restore unsuppressed module 906, and execute unsuppressed module 908. In one embodiment, the wake indication module 902 receives an indication that the device is waking from a sleep mode as described in FIG. 6, block 602. The suppressed process determination module 904 determines if the process is suppressed as described in FIG. 6, block 606. The restore unsuppressed module 906 restores the unsuppressed process as described in FIG. 6, block 608. The execute unsuppressed module 908 restores the unsuppressed module as described in FIG. 6, block 610.

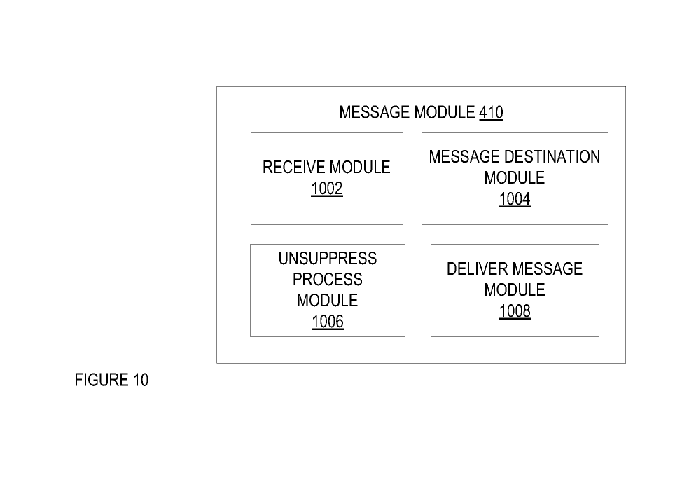

FIG. 10 is a block diagram of one embodiment of a message module 410 to unsuppress a suppressed process. In one embodiment, the message module 410 includes a receive module 1002, message destination module 1004, unsuppress process module 1006, and deliver message module 1008. In one embodiment, the receive module 1002 receives a message as described in FIG. 7, block 702. The message destination module 1004 determines if the message is destined for a suppressed process as described in FIG. 7, block 704. The unsuppress process module 1006 unsuppresses a suppressed process as described in FIG. 7, block 706. The deliver message module 1008 delivers the message to the destination process as described in FIG. 7, block 708.

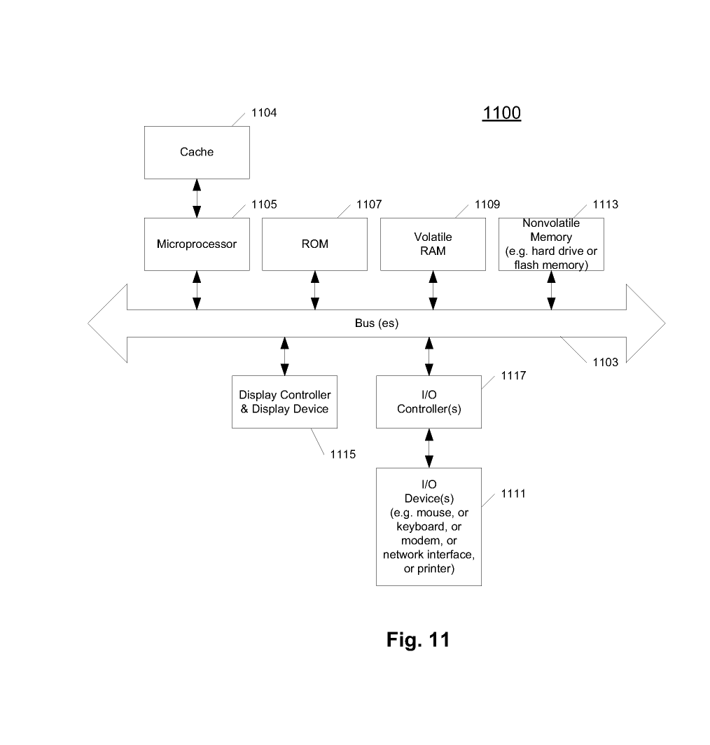

FIG. 11 shows one example of a data processing system 1100, which may be used with one embodiment of the present invention. For example, the system 1100 may be implemented including a device 100 as shown in FIG. 1. Note that while FIG. 11 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 11, the computer system 1100, which is a form of a data processing system, includes a bus 1103 which is coupled to a microprocessor(s) 1105 and a ROM (Read Only Memory) 1107 and volatile RAM 1109 and a non-volatile memory 1111. The microprocessor 1105 may retrieve the instructions from the memories 1107, 1109, 1111 and execute the instructions to perform operations described above. The bus 1103 interconnects these various components together and also interconnects these components 1105, 1107, 1109, and 1111 to a display controller and display device 1113 and to peripheral devices such as input/output (I/O) devices which may be mice, keyboards, modems, network interfaces, printers and other devices which are well known in the art. Typically, the input/output devices 1115 are coupled to the system through input/output controllers 1113. The volatile RAM (Random Access Memory) 1109 is typically implemented as dynamic RAM (DRAM), which requires power continually in order to refresh or maintain the data in the memory.

The mass storage 1111 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1111 will also be a random access memory although this is not required. While FIG. 11 shows that the mass storage 1111 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1103 may include one or more buses connected to each other through various bridges, controllers and/or adapters as is well known in the art.

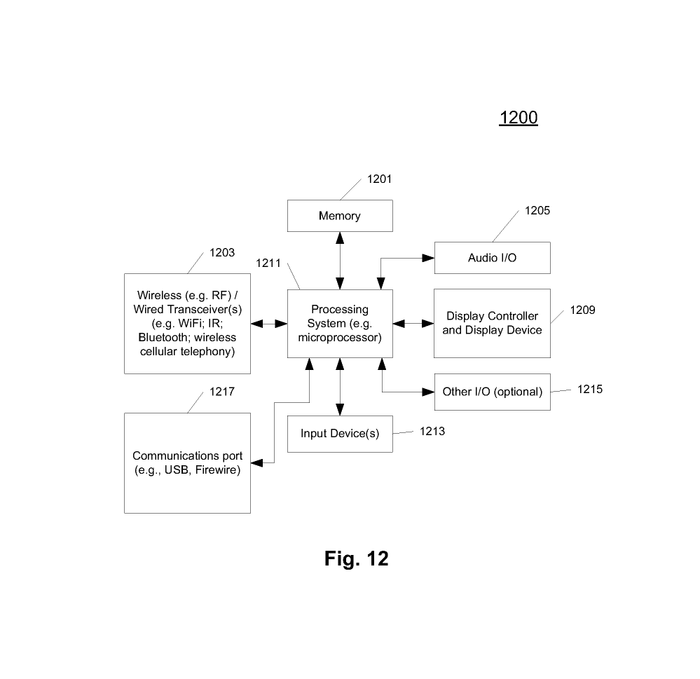

FIG. 12 shows an example of another data processing system 1200 which may be used with one embodiment of the present invention. For example, system 1200 may be implemented as a device 100 as shown in FIG. 1 or device 300 as shown in FIG. 3. The data processing system 1200 shown in FIG. 12 includes a processing system 1211, which may be one or more microprocessors, or which may be a system on a chip integrated circuit, and the system also includes memory 1201 for storing data and programs for execution by the processing system. The system 1200 also includes an audio input/output subsystem 1205, which may include a microphone and a speaker for, for example, playing back music or providing telephone functionality through the speaker and microphone.

A display controller and display device 1209 provide a visual user interface for the user; this digital interface may include a graphical user interface which is similar to that shown on a Macintosh computer when running OS X operating system software, or Apple iPhone when running the iOS operating system, etc. The system 1200 also includes one or more wireless transceivers 1203 to communicate with another data processing system, such as the system 1200 of FIG. 12. A wireless transceiver may be a WLAN transceiver, an infrared transceiver, a Bluetooth transceiver, and/or a wireless cellular telephony transceiver. It will be appreciated that additional components, not shown, may also be part of the system 1200 in certain embodiments, and in certain embodiments fewer components than shown in FIG. 12 may also be used in a data processing system. The system 1200 further includes one or more communications ports 1217 to communicate with another data processing system, such as the system 1500 of FIG. 15. The communications port may be a USB port, Firewire port, Bluetooth interface, etc.

The data processing system 1200 also includes one or more input devices 1213, which are provided to allow a user to provide input to the system. These input devices may be a keypad or a keyboard or a touch panel or a multi touch panel. The data processing system 1200 also includes an optional input/output device 1215 which may be a connector for a dock. It will be appreciated that one or more buses, not shown, may be used to interconnect the various components as is well known in the art. The data processing system shown in FIG. 12 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1200 may be a network computer or an embedded processing device within another device, or other types of data processing systems, which have fewer components or perhaps more components than that shown in FIG. 12.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “receiving,” “determining,” “resuming,” “unsuppressing,” “suppressing,” “computing,” “saving,” “transferring,” “forwarding,” “retrieving,” “marking,” “deferring,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to wakeup a device from a sleep mode, the method comprising:
receiving a signal to wakeup the device from the sleep mode, wherein the sleep mode includes a plurality of processes that were executing prior to the device being put into a sleep mode and the plurality of processes includes a suppressed process and an unsuppressed process; and
for each of the plurality of processes,
resuming execution of that process if that process is an unsuppressed process, and
deferring execution of the process if that process is a suppressed process.

2. The non-transitory machine-readable medium of claim 1, wherein the method further comprises:
receiving a message from the unsuppressed process; and
unsuppressing a suppressed process if a message is destined for the suppressed process.

3. The non-transitory machine-readable medium of claim 2, wherein the method further comprises:
forwarding the message to a destination process for the message.

4. The non-transitory machine-readable medium of claim 1, wherein the suppressed process is marked as suppressed prior to the device entering the sleep mode.

5. The non-transitory machine-readable medium of claim 1, wherein an unsuppressed process is a process that is to resume execution upon the device waking from the sleep mode.

6. The non-transitory machine-readable medium of claim 5, wherein the unsuppressed process is selected from the group consisting of a login window, window server, launch daemon, backup daemon, search indexing, and application launch board.

7. The non-transitory machine-readable medium of claim 1, wherein the sleep mode of the device is a low power mode of the device where application data in volatile memory is stored to disk and kernel memory is saved to a hibernate file.

8. A non-transitory machine-readable medium having executable instructions to cause one or more processing units to perform a method to prepare a device for sleep mode, the method comprising:
receiving a signal that indicates the device is to be put into the sleep mode, wherein the device includes a plurality of active processes that are executing;
retrieving a list of important process; and
for each of the plurality of active processes,
determining if that active process is in the list of important processes, and
marking that active process as suppressed, if that active process is not in the list of important processes, wherein execution of a suppressed process is deferred upon the device waking from sleep mode.

9. The non-transitory machine-readable medium of claim 8, wherein execution of an important process is to resume upon the device waking from sleep mode.

10. The non-transitory machine-readable medium of claim 8, wherein the important process is selected from the group consisting of a login window, window server, launch daemon, backup daemon, search indexing, and application launch board.

11. The non-transitory machine-readable medium of claim 8, wherein the sleep mode of the device is a low power mode of the device where application data in volatile memory is stored to disk and kernel memory is saved to a hibernate file.

12. A method to wakeup a device from a sleep mode, the method comprising:
receiving a signal to wakeup the device from the sleep mode, wherein the sleep mode includes a plurality of processes that were executing prior to the device being put into a sleep mode and the plurality of processes includes a suppressed process and an unsuppressed process; and
for each of the plurality of processes,
resuming execution of that process if that process is an unsuppressed process, and
deferring execution of the process if that process is a suppressed process.

13. The method of claim 12, further comprising:
receiving a message from the unsuppressed process; and
unsuppressing a suppressed process if a message is destined for the suppressed process.

14. The method of claim 13, further comprising:
forwarding the message to a destination process for the message.

15. The method of claim 12, wherein the suppressed process is marked as suppressed prior to the device entering the sleep mode.

16. The method of claim 12, wherein an unsuppressed process is a process that is to resume execution upon the device waking from the sleep mode.

17. The method of claim 16, wherein the unsuppressed process is selected from the group consisting of a login window, window server, launch daemon, backup daemon, search indexing, and application launch board.

18. The method of claim 12, wherein the sleep mode of the device is a low power mode of the device where application data in volatile memory is stored to disk and kernel memory is saved to a hibernate file.

19. A device to prepare the device for sleep mode, the device comprising:
a processor;
a memory coupled to the processor though a bus; and
a process executed from the memory by the processor to cause the processor to receive a signal that indicates the device is to be put into the sleep mode, wherein the device includes a plurality of active processes that are executing, retrieve a list of important process, and for each of the plurality of active processes, determine if that active process is in the list of important processes, and mark that active process as suppressed, if that active process is not in the list of important processes, wherein execution of a suppressed process is deferred upon the device waking from sleep mode.

20. The device of claim 19, wherein execution of an important process is to resume upon the device waking from sleep mode.
